(19) United States
(12) Patent Application Publication
(10) Pub. No.: US 2024/0139656 A1
(43) Pub. Date: May 2, 2024

(54) SANITARY MEMBRANE LEAF PACKET AND MEMBRANE ELEMENT INCLUDING SAME

(71) Applicant: Solecta, Inc., Oceanside, CA (US)

(72) Inventors: David Richard Kimber, Oceanside, CA (US); Christopher James Kurth, Eden Prairie, MN (US)

(21) Appl. No.: 18/502,203

(22) Filed: Nov. 6, 2023

Related U.S. Application Data
(63) Continuation of application No. PCT/US2022/026927, filed on Apr. 29, 2022.
(60) Provisional application No. 63/185,991, filed on May 7, 2021.

(51) Int. Cl. B01D 29/39; B01D 63/10; C09J 11/06

(52) U.S. Cl. CPC B01D 29/39; B01D 63/1031; C09J 11/06; B01D 2313/042

(57) ABSTRACT

The disclosure relates to a membrane leaf packet, and a spiral membrane element including a plurality of such membrane leaf packets, including such elements exhibiting enhanced sanitary properties. Such membrane elements can be used for filtration, for example, in food-related fields, including filtering dairy, sugar and/or other liquid streams.

### CROSS-REFERENCE TO RELATED APPLICATIONS

This application is a continuation of International Application Serial No. PCT/US2022/026927, filed Apr. 29, 2022, which claims the benefit of U.S. Provisional Patent Application No. 63/185,991, filed May 7, 2021, the entire contents of which are hereby incorporated by reference.

### FIELD

The disclosure relates to a membrane leaf packet, and a spiral membrane element including a plurality of such membrane leaf packets, including such elements exhibiting enhanced sanitary properties. Such membrane elements can be used for filtration, for example, in food-related fields, including filtering dairy, sugar and/or other liquid streams.

### BACKGROUND

In a typical spiral-wound filtration element, leaves of the element are compiled of several materials, including a folded sheet of membrane. The creases at the folded area of each membrane sheet can be weak spots in the filter and are susceptible to damage from spacers used to convey feed solution through the element. In some filtration applications, including certain microfiltration and ultrafiltration applications, this area is deadened by applying a liquid adhesive on the membrane at this location. For reverse osmosis and nanofiltration elements, an adhesive is often applied to the backside (fabric side) of the membrane and then covered with tape, simply to cover the adhesive so that automated rolling equipment can handle the membrane leaves without the adhesive creating problems in the equipment.

### SUMMARY

The disclosure provides a membrane leaf packet in which creases contain an adhesive on the backside of the membrane but do not include a tape, as well as a spiral membrane element including a plurality of such membrane leaf packets. The disclosure also relates to corresponding systems and methods of use.

According to this disclosure, a membrane leaf packet, and a corresponding spiral-wound filtration element can be used in ultrafiltration, microfiltration, nanofiltration, reverse osmosis and gas separation.

In some embodiments, a membrane leaf packet, and a corresponding filtration element can exhibit improved sanitary properties compared to some known filtration elements. As an example, in some known filtration leaf packets that include an adhesive/tape configuration, the tape-adhesive bond can weaken over time, especially in applications with frequent cleaning cycles. When this bond weakens, low-flow channels can be created underneath the surface of the tape, and the low-flow channels may not get cleaned properly. As a result, these channels can trap organic material and promote the growth of bacteria. This problem is exacerbated when the tape does not cover the applied adhesive area exactly because this can leave behind tape area that can be delaminated from the membrane fabric over time. These issues are avoided with a membrane leaf packet and related elements according to the disclosure.

In certain embodiments, a membrane leaf packet according to the disclosure can be prepared without using, for example, ultraviolet (UV) curing. This can avoid the cost and complexity that can be associated with UV curing technologies. As an example, UV curing can involve the use of photoinitiators which may have undesirable health effects.

In some embodiments, a filtration membrane leaf packet according to the disclosure can be prepared without using, for example, pressure and heat to fuse a reinforcing strip. This can avoid the cost and complexity that can be associated with such fusing processes.

In certain embodiments, a filtration membrane leaf packet according to the disclosure can be prepared without using, for example, a swelling solvent to solidify the layer, e.g., a reverse osmosis layer, on the surface of the membrane. This can avoid the cost and complexity that can be associated with such fusing processes.

In addition to improving the sanitary nature of the fold protection by removing the region between the tape and adhesive by physically removing that interface, methods according to the disclosure can also afford a surface that is less conducive to microbial biofilm formation. Without wishing to be bound by theory, it is believed that by curing the adhesive in contact with the removable non-stick/protective sheet, the adhesive cures with chemical moieties preferentially oriented to minimize energy differences with the protective sheet. In general, the non-stick protective sheet can be formed of a monolithic non-stick material, or the sheet can be formed of multiple layers of material with the layer contacting the adhesive being a non-stick material. As used herein, a non-stick material or a non-stick sheet has a coefficient of friction of at most 0.4 (e.g., at most 0.3, at most 0.2, at most 0.1, at most 0.8) according to ASTM D-184. As an example, when the sheet is formed of a dense polyolefin or a fluorinated polyolefin, such as Teflon®, the resulting cured adhesive surface can have a lower surface energy than would be generated if the adhesive were covered by a tape during the curing process. This low energy surface of the fold protect surface can reduce its ability to bind solutes strongly enough to withstand cleaning cycles and thus can maintain more sanitary conditions while in service. Typically, this surface structuring would not change the overall chemical composition of the fold protect material, but surface specific analytical techniques such as contact angle goniometry, or microbial plating methods, could be used to determine such changes. For example, contact angle goniometry could be used to measure the magnitude of the surface energy drop when cured by this method, and microbial plating would be used to determine colony count before and after a cleaning cycle. In some embodiments, after curing, the adhesive has a contact angle of greater than 15° (e.g., greater than 25°, greater than 50°, greater than 75°, greater than 80°, greater than 85°) according to ASTM D5946.

The fold protection disclosed herein may also improve the cleanliness of the fold by reducing the surface roughness of the cured adhesive. In some embodiments, the protective (non-stick) film used while the adhesive is curing serves as a template for the final adhesive surface topology and so by use of a substantially flat film, an adhesive surface with little roughness may be achieved. Examples of roughness ranges include but are not limited to less than 100 nanometer (nm) Root Mean Square (RMS) (e.g., less than 50 nm RMS, less than 20 nm RMS, less than 10 nm RMS, less than 5 nm RMS, less than 2 nm RMS). Without wishing to be bound by theory, it is believed that such low roughness can reduce (e.g., minimize) the number of locations where microorganisms can deposit and be shielded by the surface roughness from effects of bulk fluid flow and the effects of inertial lift. The absence of such rough locations may also reduce the adhesion strength of particles with the surface by physically reducing the surface area available for a solute to interact with.

In a first general aspect, the disclosure provides a method that includes: applying an adhesive to a fold region of a membrane; applying a non-stick material to the adhesive; allowing the adhesive to cure; and after the adhesive cures, removing the non-stick material to provide a leaf packet.

In some embodiments, the method further includes, before the adhesive cures, applying pressure to the non-stick material to force the adhesive into the membrane. The applied pressure can be at least one pound per square inch gauge (psig) and/or at most 1000 psig.

In some embodiments, the non-stick material has a coefficient of friction of at most 0.4 ASTM D-184.

In some embodiments, the non-stick material includes a monolithic sheet of the non-stick material.

In some embodiments, the non-stick material includes a multilayer sheet of materials, wherein at least one layer of the multilayer sheet includes the non-stick material.

In some embodiments, the non-stick material includes at least one member selected from dense polyolefins, polyvinylidenefluorides, polyethylenechlorotrifluoroethylenes, fluorinated ethylene-propylenes, polychlorotrifluoroethylenes, and polytetrafluoroethylenes.

In some embodiments, the membrane includes a polymer.

In some embodiments, the membrane includes a composite membrane.

In some embodiments, the membrane includes at least one material selected from cellulose acetates, polyamides, polyether ether ketones, polyvinylidene fluorides, polyacrylonitriles, polyvinyl chlorides, chlorinated-polyvinyl chlorides, polyolefins, polysulfones, and polyethersulfones.

In some embodiments, a surface of the cured adhesive has a contact angle greater than 15°.

In some embodiments, a surface of the cured adhesive has a roughness of less than 100 nm RMS.

In some embodiments, the adhesive has viscosity of from 100,000 cP to 500 cP.

In some embodiments, the adhesive includes a polymer.

In some embodiments, the adhesive includes at least one member selected from urethanes, epoxies, silicones and acrylates.

In some embodiments, the adhesive includes a cyanoacrylate.

In some embodiments, the adhesive includes at least one member selected from hot melt adhesives, thermosetting adhesives, pressure sensitive adhesives, contact adhesives, two-component adhesives and three-component adhesives.

In some embodiments, the adhesive includes a reactive hot melt adhesive.

In some embodiments, the adhesive is devoid of a photoinitiator.

In some embodiments, curing the adhesive does not include UV curing.

In some embodiments, the method does not include using fusing a reinforcing strip.

In some embodiments, the method does not include using a swelling agent.

In some embodiments, the method further includes, before applying the adhesive, folding the membrane. The adhesive can be applied to a folded portion of the membrane. The adhesive can be applied to a non-stick material, and subsequently applied to a folded portion of the membrane. The adhesive is applied to a fabric side of a folded portion of the membrane.

In some embodiments, the method further includes repeating the method to provide a plurality of leaf packets. The method can further include configuring the filter elements as a spiral wound filter element. The spiral wound filter element can include at least one member selected from ultrafiltration filter elements, microfiltration filter elements, nanofiltration filter elements, reverse osmosis filter elements, and gas separation filter elements.

In a second general aspect, the disclosure provides a filter element made by a method disclosed herein.

In a third general aspect, the disclosure provides a filter leaf packet, that includes: a folded membrane including a crease; and an adhesive disposed at the crease on the outside of the folded leaf packet, wherein a surface of the adhesive is uncovered.

In some embodiments, the membrane has a fabric side, and the adhesive is disposed on the fabric side of the membrane.

In some embodiments, the filter leaf pack further includes a spacer disposed between folded portions of the membrane. The membrane can contact the spacer. The membrane can be between the spacer and the adhesive.

In some embodiments, the adhesive is from 0.001 inch to four inches wide.

In some embodiments, the membrane includes a polymer.

In some embodiments, the membrane includes a composite membrane.

In some embodiments, the membrane includes at least one material selected from cellulose acetates, polyamides, polyether ether ketones, polyvinylidene fluorides, polyacrylonitriles, polyvinyl chlorides, chlorinated-polyvinyl chlorides, polyolefins, polysulfones, and polyethersulfones.

In some embodiments, a surface of the adhesive has a contact angle of at least 15°.

In some embodiments, a surface of the adhesive has a roughness of less than 100 nm RMS.

In some embodiments, the adhesive has viscosity of from 100,000 cP to 500 cP.

In some embodiments, the adhesive includes a polymer.

In some embodiments, the adhesive includes at least one member selected from urethanes, epoxies, silicones and acrylates.

In some embodiments, the adhesive includes a cyanoacrylate.

In some embodiments, the adhesive includes at least one member selected from hot melt adhesives, thermosetting adhesives, pressure sensitive adhesives, contact adhesives, two-component adhesives and three-component adhesives.

In some embodiments, the adhesive includes a reactive hot melt adhesive.

In some embodiments, the adhesive is devoid of a photoinitiator.

In some embodiments, the adhesive is applied to a fabric side of a folded portion of the membrane.

In some embodiments, the adhesive is cured.

In a fourth general aspect, the disclosure provides a membrane filter element that includes a plurality of filter leaf packets as disclosed herein.

In some embodiments, the membrane filter element further includes a permeate collection tube. The filter leaf packets can be wound around the permeate collection tube.

In some embodiments, a filter leaf packet is positioned on each side of a membrane envelope.

In some embodiments, each filter leaf packet includes a substantially rectangular membrane sheet folded upon itself to define two membrane leaves. Front sides of each leaf can face each other, and the fold can be axially aligned with an edge of the membrane envelope. The fold can be parallel with the permeate collection tube.

In some embodiments, the membrane filter element further includes a feed spacer between facing front sides of the folded membrane sheet.

In some embodiments, the membrane filter element further includes a feed spacer that is printed on the surface of the membrane.

In some embodiments, the folded membrane sheets are open along their radial ends to permit feed fluid to flow in an axial direction through the membrane filter element.

In some embodiments, the axial direction is parallel with the permeate collection tube.

In some embodiments, back sides of two adjacent membrane leaves are joined at their back sides. The back sides can be sealed about portions of their periphery to enclose a permeate spacer to form the membrane envelope. The membrane envelope and feed spacer can be wound or rolled around the permeate collection tube and held in place. The membrane envelope and feed spacer can be held in place by tape, such as a self-adhering mesh tape. The membrane filter element can be configured so that the membrane envelope and feed spacer are held in place until an outer housing is secured about the partially constructed filter element.

### BRIEF DESCRIPTION OF THE DRAWINGS

Illustrative embodiments are described below with reference to the drawings, in which:

FIG. 1 is a perspective, partially cut-away view of a membrane leaf packet;

FIG. 2 shows a view of a step in the process of making a membrane leaf packet; and

FIG. 3 is a relatively close-up, perspective, partially cut-away view of the folded region of a membrane leaf packet with the sheet of non-stick material; and

FIG. 4 is a perspective, partially cut-away view of a spiral wound filter element.

### DESCRIPTION OF ILLUSTRATIVE EMBODIMENTS

The disclosure generally relates to spiral-wound elements made of sheet-like semipermeable membrane material, and methods of making such elements, including spiral-wound cross flow membrane elements utilizing membrane filter sheets, which are folded upon themselves to create leaves that are then spirally wound about a central porous tube. In general, the leaves are creased at a fold line to form envelopes about a central mesh or spacer material, which serves as the feed path or permeate flow space. The disclosure also relates to corresponding systems including such membrane elements, and the use thereof.

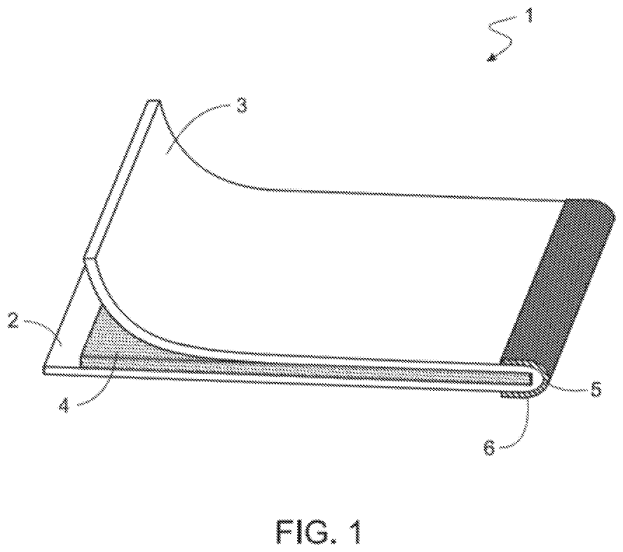

FIG. 1 shows a membrane leaf packet 1 according to the disclosure. The membrane leaf packet 1 includes a membrane front side 2 and a membrane back side/fabric side 3. The membrane has a fold/crease 5 to which an adhesive 6 is applied. A feed spacer 4 is positioned between the folded portions of the membrane front side 2.

In general, any appropriate membrane material can be used for the membrane. The selection of membrane sheet is generally dependent upon a desired application, feed source, solute, and foulants. In some embodiments, a membrane material is a cellulose acetate, a polyamide, a polyether ether ketone (PEEK), a polyvinylidene fluoride (PVDF), a polyacrylonitrile (PAN), a polyvinyl chloride (PVC), a chlorinated-polyvinyl chloride (cPVC), a polyolefin, a polysulfone or a polyethersulfone. While early RO and NF flat sheet membranes were made from cellulose acetate materials, polyamide, asymmetric polysulfone and polyethersulfones membranes along with composite membranes have become more common in recent years. An example of a composite membrane sheet is the FilmTec Corporation FT-30 ® membrane which includes a bottom layer (back side) of a nonwoven polyester material web (e.g. PET scrim), a middle layer of a microporous polymer such as polysulfone having a thickness of about 25-125 microns, and top layer (front side) comprising a thin film polyamide layer having a thickness less than about 1 micron and more commonly from about 0.010 to 0.1 micron. The polyamide layer can be created by an interfacial polycondensation reaction between a polyfunctional amine monomer and a polyfunctional acyl halide monomer upon the surface of the microporous polysulfone as described in U.S. Pat. Nos. 4,277,344 and 5,658,460 to Cadotte et al; and U.S. Pat. No. 6,878,278 to Mickols. Methods of modifying such polyamide membranes are described in U.S. Pat. No. 5,876,602 to Jons et. al.; U.S. Pat. Nos. 5,755,964, 6,280,853 and WO 2007/133362 to Mickols; U.S. Pat. Nos. 4,888,116; 4,765,897; 4,964,998 to Cadotte et. al. and US 2007/0251883 and US 2008/0185332 to Niu et al.

Generally, the adhesive may be selected as desired. Examples of adhesives include urethanes, epoxies, silicones and acrylates (e.g., cyanoacrylates). In some embodiments, the adhesive can be at least one of a hot melt adhesive (e.g., a reactive hot melt adhesive), a thermosetting adhesive, a pressure sensitive adhesive, a contact adhesive, a multi-component adhesive (e.g., a two-component adhesive, a three-component adhesive). In general, a hot melt adhesive is an adhesive is formed of a base material with various additives. Generally, the composition of a hot melt adhesive is predominantly formulated to have a glass transition temperature below the minimum service temperature and a reasonably high melt temperature. Examples of hot melt adhesives include ethylene-vinyl acetate (EVA) copolymers, polyolefins (e.g., polyethylene, oxidized polyethylene, atactic polypropylene (APP), polybutene-1), polyamides and polyesters. In general, a reactive hot melt adhesive is an adhesive that is heated before processing and applied in molten state such that, when the adhesive cools, the adhesive builds up its strength through a physical hardening process. Water molecules (from the adherend or the air) then trigger a chemical reaction which transforms the adhesive into an elastomer with relatively strong crosslinking. In some embodiments, a reactive hot melt adhesive is based on polyurethane or polyolefins. In general, a thermosetting adhesive is a relatively soft solid or relatively viscous liquid pre-polymer that is irreversibly reacted with a curing agent to create extensive cross-linked polymer chains that produce an infusible and insoluble polymer network. Generally, once hardened, a thermoset polymer cannot be melted for reshaping. Examples of thermosetting adhesives include polyurethanes, epoxies, polyester resin fiberglass systems, benzoxazines, polyimides, cyanate esters, and Duroplast. In general, a pressure sensitive adhesive is a type of nonreactive adhesive which forms a bond when pressure is applied to bond the adhesive with a surface. No chemicals (solvent, water, etc.) or heat are required to activate the adhesive. The strength of the bond is influenced by the amount of pressure used to apply the adhesive to the surface. Once the adhesive and the adherend are in proximity, there are also molecular interactions such as van der Waals forces involved in the bond, which contribute significantly to the ultimate bond strength. Pressure sensitive adhesives can be made with a variety of elastomers compounded with a tackifier, or based on acrylics which have sufficient tack on their own. Examples of pressure sensitive adhesives include adhesives made with natural rubber, styrene-butadiene rubbers, styrene-block copolymers, acrylics, and silicones. Pressure sensitive adhesives can also include adhesive tapes such as masking tape, duct tape or cellophane tape. Generally, contact adhesives are adhesives that have high adhesive capacity and near instant adhesion. Contact adhesives are usually applied in thin layers to both surfaces and allowed to dry for some time before the two surfaces are pushed together. Examples of contact adhesives include natural rubber and polychloroprene (Neoprene). In general, a multi-component adhesive hardens by mixing two or more components which chemically react. The reaction causes polymers to cross-link into acrylates, urethanes and epoxies. Examples of two-component adhesives include polyester resin-polyurethane resin, polyol-polyurethane resin, and acrylic polymer-polyurethane resin. In general, a three-component adhesive utilizes a curing agent and two different bases (a relatively fast base and a relatively slow base) in a variable ratio to achieve desirable curing properties. Examples of three-component bases include examples include polyurethanes, epoxies, and silicones.

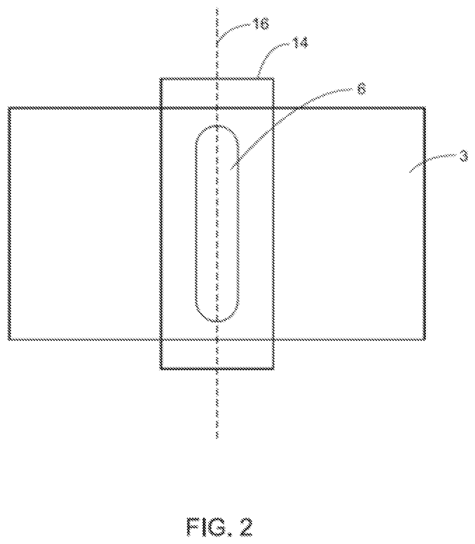

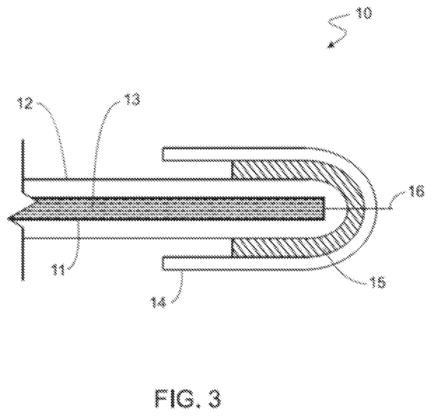

An illustrative process according to the disclosure includes the following. Membrane leaves are cut to size and folded in half, with the filtration layers of the membrane on the inside of the folded leaf. An adhesive (e.g., a glue, such as a two-part urethane or epoxy) is applied (e.g., via air-powered glue cartridges) onto the backside (fabric side) of the membrane leaf. Typically, a bead of the adhesive applied right on top of the folded area. The bead of adhesive is covered with a sheet of material that does not stick to the adhesive. This is depicted illustratively in FIGS. 2 and 3. In FIG. 2, a bead of adhesive 6 on the membrane back side/fabric side 3, and a sheet of non-stick material 14 covering the bead of adhesive 6. FIG. 3 shows a leaf packet 10, which includes a membrane front side 11, a membrane back side/fabric side 12, a feed spacer 13 between the folded portions of the membrane front side 11, an adhesive 15 applied at a fold/crease 16, and the sheet of non-stick material 14 shown. In some embodiments, the non-stick material 14 is formed of a monolithic sheet of a non-stick material. In certain embodiments, the non-stick material 14 is formed of a multi-layer sheet that includes one or more substrate materials and a layer of non-stick material that is the material that contacts the adhesive. Examples of non-stick materials include dense polyolefins, polyvinylidenefluoride, polyethylenechlorotrifluoroethylene, fluorinated ethylene-propylene, polychlorotrifluoroethylene, polytetrafluoroethylene, i.e., PTFEs (e.g., Teflon®). Examples of materials that can be used as templates include non-stick materials and materials that are not non-stick materials. In some embodiments, pressure is applied to the bead of adhesive to help press the adhesive into the fabric side of the membrane, so that the adhesive sufficiently penetrates the membrane layers, e.g., up to the filtration layer in the case of a reverse osmosis RO membrane and forms a protection area of the correct width. In certain embodiments, the applied pressure is at least one pound per square inch gauge (psig) (e.g., at least, at least 10 psig, at least 50 psig) and at most 1000 psig (e.g., at most 500 psig). The pressure can be applied manually or via an automated process. Whether such pressure is applied or not, after the adhesive cures, the sheet of non-stick material is removed so that all that is remaining in the membrane leaf is a solid layer of glue, which reinforces the fold protection area and sufficiently penetrates the membrane. In some embodiments, the non-stick material is removed so as not to create portions of cured adhesive with excessive surface roughness. In some embodiments, after removal of the non-stick material, the cured adhesive has a surface roughness is less than 100 nm RMS (e.g., less than 50 nm RMS, less than 20 nm RMS, less than 10 nm RMS, less than 5 nm RMS, less than 2 nm RMS). Such removal of the non-stick material allows the material to be reused. A plurality of such leaves are rolled into a spiral wound element.

In some embodiments, an adhesive can have a viscosity range of between 100,000 centipoise (cP) and 500 cP (e.g., or between 75,000 cP and 2,000 cP, between 40,000 cP and 5,000 cP, between 25,000 and 15,000 cP). In certain embodiments, the size of the bead of adhesive applied is controlled so that the final width is between 0.5 inch and 4 inches (e.g., between one inch and 2 inches). In some embodiments, a protective (non-stick) sheet can have a width greater than the largest width of the final glue line. In certain embodiments, the protective sheet can have a width between 0.001 inch and 4 inches (e.g., between 0.002 inch and 3 inches).

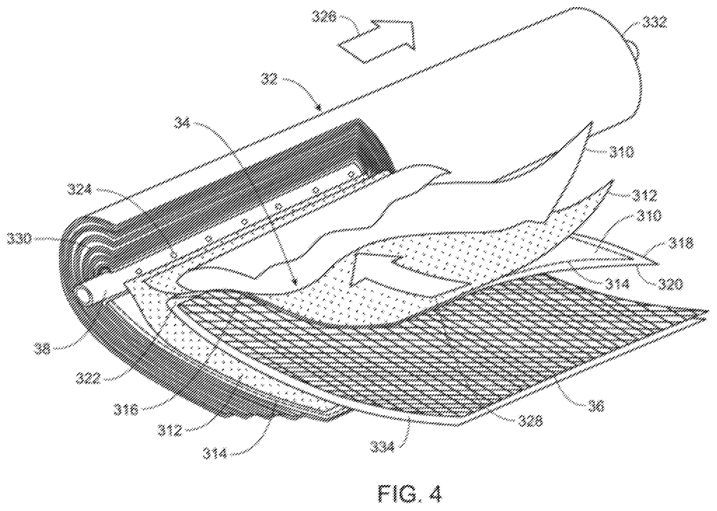

FIG. 4 shows a spiral wound filter element formed by winding one or more membrane envelopes 34 and feed spacers 36 about a permeate collection tube 38. In general, each membrane envelope 34 includes two substantially rectangular membrane sheets 310 surrounding a permeate channel spacer sheet 312. This sandwich-type structure is secured together, e.g., by an adhesive 314, along three edges 316, 318, 320, while a fourth edge 322 abuts the permeate collection tube 38 so that the permeate spacer 312 is in fluid contact with openings 324 passing through the permeate collection tube 38.

A membrane leaf packet is positioned on each side of the membrane envelope 34. Each leaf packet is shown including a substantially rectangular membrane sheet 310 folded upon itself to define two membrane leaves wherein the front sides 334 of each leaf are facing each other and the fold is axially aligned with the fourth edge 322 of the membrane envelope 34, i.e., parallel with the permeate collection tube 38. The feed spacer 36 is shown located between facing front sides 334 of the folded membrane sheet 310 and is open along its radial ends to permit feed fluid to flow in an axial direction (i.e. parallel with the permeate collection tube 38) through the filter element. In this embodiment, the membrane envelope 34 is formed by joining the back sides of two adjacently positioned membrane leaves. While not shown, additional intermediate layers may also be included in the assembly.

Arrows shown in FIG. 4 represent the approximate flow directions 326, 328 of feed and permeate during operation. Feed flow 326 is from the inlet end 330 to the outlet end 332 across the front side 334 of the membrane. Permeate flow 328 is along the permeate spacer 312 in a direction approximately perpendicular to the feed flow 326. Actual flow paths vary with details of construction and operating conditions.

During filter element fabrication, permeate spacers 312 are attached about the circumference of the permeate collection tube 38 and membrane leaves are interleaved therebetween. The back sides of adjacently positioned membrane leaves are sealed about portions of their periphery 316, 318, 320 to enclose the permeate spacer 312, i.e. form the membrane envelope 34. The membrane envelope(s) 34 and feed spacer(s) 36 are wound or rolled about the permeate collection tube and then held in place such as by tape (e.g. self adhering mesh tape) or other means until an outer housing can be secured about the partially constructed filter element 32. The sealant used for sealing the edges of the membrane envelope preferably permits relative movement of the various sheet materials during the winding process. That is, the cure rate or period of time before which the sealant becomes tacky is preferably longer than that required to assemble and wind the membrane envelopes and membrane leaves about the permeate collection tube.

Materials for constructing various components of spiral wound filter elements are well known in the art and can be selected as appropriate. Permeate collection tubes are typically made from plastic materials such as acrylonitrile-butadiene-styrene, polyvinyl chloride, chlorinated polyvinyl chloride, polysulfone, poly(phenylene oxide), polystyrene, polypropylene, polyethylene or the like. Tricot polyester materials are commonly used as permeate spacers. Representative feed spacers are described in more detail in U.S. Pat. No. 6,881,336 to Johnson, which is incorporated by reference herein. Representative example feed spacers include polyethylene, polyester, and polypropylene mesh materials, or a blend of those materials. The housing may be constructed from a variety of materials including stainless steel, tape and PVC material; however a common filter element housing material is made from fiber reinforced plastics, e.g. long glass fibers coated with a thermoplastic or thermoset resin. During filter element fabrication, long glass fibers are wound about the partially constructed filter element and resin (e.g. liquid epoxy) is applied and hardened. The ends of filter elements can be fitted with an anti-telescoping device or end cap (not shown) designed to prevent membrane envelopes from shifting under the pressure differential between the inlet and outlet ends of the filter element. The end cap is commonly fitted with an elastomeric seal (not shown) to form a tight fluid connection between the filter element and an external pressure vessel (not shown). Examples of end cap designs are described in U.S. Pat. No. 6,632,356 to Hallan, et al., including FilmTec Corporation iLEC® interlocking end caps. Additional details regarding various components and construction of spiral wound filter elements are provided in the literature, see for example: U.S. Pat. No. 5,538,642 to Solie describes a technique for attaching the permeate spacer to the permeate collection tube, WO 2007/067751 to Jons et. al describes trimming operations and the use of a UV adhesive for forming a insertion point seal, and U.S. Pat. No. 5,096,584 to Reddy et al. describes various embodiments, components and construction techniques particularly suited for gas separations, each of which is incorporated by reference herein.

The entire disclosure of U.S. Pat. No. 7,875,177 (Haynes et al.) is incorporated by reference herein.

1.-68. (canceled)

69. A method, comprising:
(i) applying an adhesive to a fold region of a membrane;
(ii) applying a non-stick material to the adhesive;
(iii) allowing the adhesive to cure; and
(iv) after the adhesive cures, removing the non-stick material to provide a leaf packet.

70. The method of claim 69, further comprising, before the adhesive cures, applying pressure to the non-stick material to force the adhesive into the membrane.

71. The method of claim 70, wherein the applied pressure is from at least one pound per square inch gauge (psig) to at most 1000 psig.

72. The method of claim 69, wherein the non-stick material has a coefficient of friction of at most 0.4 ASTM D-184.

73. The method of claim 69, wherein the non-stick material comprises a monolithic sheet of the non-stick material or a multilayer sheet of materials, wherein at least one layer of the multilayer sheet comprises the non-stick material.

74. The method of claim 69, wherein the non-stick material comprises at least one member selected from the group consisting of dense polyolefins, polyvinylidenefluorides, polyethylenechlorotrifluoroethylenes, fluorinated ethylene-propylenes, polychlorotrifluoroethylenes, and polytetrafluoroethylenes.

75. The method of claim 69, wherein the membrane comprises a polymer.

76. The method of claim 69, wherein the membrane comprises a composite membrane comprising at least one material selected from the group consisting of cellulose acetates, polyamides, polyether ether ketones, polyvinylidene fluorides, polyacrylonitriles, polyvinyl chlorides, chlorinated-polyvinyl chlorides, polyolefins, polysulfones, and polyethersulfones.

77. The method of claim 69, wherein a surface of the cured adhesive has a contact angle greater than 15° or a roughness of less than 100 nm RMS.

78. The method of claim 69, wherein the adhesive has viscosity of from 100,000 cP to 500 cP.

79. The method of claim 69, wherein the adhesive comprises a polymer.

80. The method of claim 69, wherein the adhesive comprises at least one member selected from the group consisting of urethanes, epoxies, silicones and acrylates.

81. The method of claim 69, wherein the adhesive comprises a cyanoacrylate.

82. The method of claim 69, wherein the adhesive comprises at least one member selected from the group consisting of hot melt adhesives, thermosetting adhesives, pressure sensitive adhesives, contact adhesives, two-component adhesives and three-component adhesives.

83. The method of claim 69, wherein the method does not include using fusing a reinforcing strip, UV curing of the adhesive, or using a swelling agent.

84. The method of claim 69, further comprising, before applying the adhesive, folding the membrane, wherein the adhesive is applied to a non-stick material, and subsequently applied to a folded portion of the membrane.

85. The method of claim 69, further comprising repeating the method to provide a plurality of leaf packets.

86. The method of claim 85, further comprising configuring the filter elements as a spiral wound filter element.

87. The method of claim 86, wherein the spiral wound filter element comprises at least one member selected from the group consisting of ultrafiltration filter elements, microfiltration filter elements, nanofiltration filter elements, reverse osmosis filter elements, and gas separation filter elements.

88. The method of claim 69, wherein the cured adhesive has a lower surface energy than an adhesive covered by a tape during the curing process.
